(19) United States
(12) Patent Application Publication
(10) Pub. No.: US 2008/0270941 A1
(43) Pub. Date: Oct. 30, 2008

(54) USER CONTENT MANAGEMENT METHOD IN COMMUNICATION TERMINAL

(75) Inventors: Jung Hun KIM, Busan Metropolitan City (KR); Young Ho Rhee, Seoul (KR); Jae Hwan Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/112,413

(22) Filed: Apr. 30, 2008

(30) Foreign Application Priority Data
Apr. 30, 2007 (KR) 2007-0042157

(51) Int. Cl. G06F 3/048

(52) U.S. Cl. 715/830; 715/810

(57) ABSTRACT

A user content management method in a communication terminal is provided. A virtual wheel in which one or more content icons corresponding to one or more items of user content and generation times of the one or more items of user content in vicinity of the content icons are arranged in temporal order according to generation time.

### PRIORITY

This application claims priority under 35 U.S.C. §119(a) to an application entitled “USER CONTENT MANAGEMENT METHOD IN COMMUNICATION TERMINAL” filed in the Korean Intellectual Property Office on Apr. 30, 2007 and assigned Serial No. 2007-0042157, the disclosure of which is incorporated herein by reference.

### BACKGROUND OF THE INVENTION

1. Field of the Invention

The present invention relates generally to a user content management method in a communication terminal, and more particularly, to a user content management method for comprehensively searching user contents stored in a communication terminal.

2. Description of the Prior Art

With the rapid popularization of communication terminals, communication terminals are now able to provide various additional functions in addition to their basic communication function. For example, communication terminals are capable of storing a large amount of information in response to user requirements. Information stored in the communication terminal includes various items of user content, which may be identified according to the user requirements.

In the prior art, when searching items of user content stored in the communication terminal, the user was made to search for a desired item of user content by first entering a predetermined menu. Typically, communication terminals arrange the items of user content in a list form or in a lattice form through individual menus, causing the user to experience inconvenience in selecting an item of user content.

### SUMMARY OF THE INVENTION

The present invention has been made to address at least the above problems and/or disadvantages, and to provide at least the advantages described below. Accordingly, an aspect of the present invention provides a user content management method that comprehensively searches items of user content stored in a communication terminal.

Another aspect of the present invention provides a user content management method enabling easy selection of an item of user content requested by a user of a communication terminal.

According to one aspect of the present invention, a user content management method in a communication terminal is provided. A virtual wheel in which one or more content icons corresponding to one or more items of user content and generation times of the one or more items of user content in vicinity of the content icons are arranged in temporal order according to generation time.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram showing a configuration of a communication terminal according to an embodiment of the present invention;

FIG. 2 is a flow chart showing a user content management method according to an embodiment of the present invention;

FIG. 3 is a flow chart showing a method of processing items of user content in the user content management method of FIG. 2;

FIG. 4 is a flow chart showing a method of searching for an item of user content in the user content management method of FIG. 2; and

FIGS. 5A to 5C are display screen output views in the process of searching for an item of user content of FIG. 4.

### DETAILED DESCRIPTION OF THE PREFERRED EMBODIMENTS

Preferred embodiments of the present invention are described in detail with reference to the accompanying drawings. The same reference numbers are used throughout the drawings. Detailed descriptions of constructions or processes known in the art may be omitted to avoid obscuring the subject matter of the present invention.

In the specification of the present invention, “user content” means information stored in a communication terminal or information to be identified by selecting an item according to a request from a terminal user. For example, the user content may be a call, a message, an MP3 file, an image, or a memo.

“Generation time” means a date and time at which an item of user content is created by the communication terminal. For example, the generation time of an item of user content may be the time of call reception, call transmission, message reception, message transmission, MP3 file download, photographing, image reception, or memo preparation.

“Content icon” is an image representing an item of user content. If the item of user content is an image or contains a thumbnail, the content icon of the item of user content may be the thumbnail itself. Otherwise, the content icon of the item of user content may be an image set to the user content. If the item of user content corresponding to the content icon has been received from a counterpart terminal or transmitted to the counterpart terminal, the content icon may represent information of the counterpart terminal user, such as a name, a telephone number, or an e-mail address.

“Virtual wheel” is a tool for arranging content icons and a generation times of the content represented by the content icon in temporal order. The virtual wheel rotates according to a request from the terminal user. The virtual wheel may include a first virtual wheel and a second virtual wheel. The first virtual wheel is a tool for arranging the content icon and the second virtual wheel is a tool for arranging the generation time of the corresponding content. If one of the first and second virtual wheels rotates, the other virtual wheel rotates synchronously. That is, the content icon and the generation time of the corresponding content icon rotate synchronously corresponding to the user content.

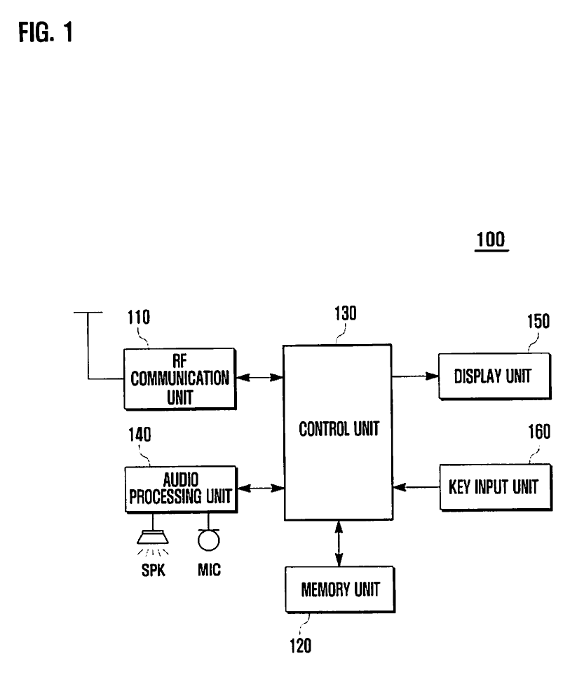

FIG. 1 is a block diagram showing a configuration of a communication terminal according to an embodiment of the present invention. The embodiment of the present invention is described assuming that the communication terminal is a mobile phone.

Referring to FIG. 1, a communication terminal 100 includes a radio frequency (RF) communication unit 110, a memory unit 120, a control unit 130, an audio processing unit 140, a display unit 150, and a key input unit 160.

The RF communication unit 110 performs a wireless communication function of the communication terminal 100. The RF communication unit 110 includes an RF transmitter for up-converting the frequency of a signal to be transmitted and amplifying the signal, and an RF receiver for low-noise amplifying a received signal and down-converting the frequency of the signal.

The memory unit 120 may include a program memory and a data memory. The program memory stores operating programs of the communication terminal 100 and user content management programs. The data memory stores data generated during execution of the programs. The memory unit 120 further stores items of user content and content icons of the items of user content generated by the communication terminal 100.

The control unit 130 controls general operation of the communication terminal 100 and includes a data processing unit having a transmitter for encoding and modulating a signal to be transmitted, and a receiver for decoding and demodulating a received signal. The data processing unit may include a modem and a codec. The codec includes a data codec for processing packet data and an audio codec for processing an audio signal.

If a search for an item of user content is requested, the control unit 130 arranges and displays content icons and a generation times in a virtual wheel corresponding to individual items of user content stored in the memory unit 120. The control unit 130 may arrange the content icons and generation times in different virtual wheels by separating the content icons and generation times. A virtual wheel for arranging the content icons and another virtual wheel for arranging the generation times may be disposed side by side. The control unit 130 controls rotation of the virtual wheels according to a request from the user of the communication terminal 100. In situations in which the content icons and generation times are arranged in different virtual wheels, the control unit 130 rotates the virtual wheel for the content icons and the virtual wheel for the generation times synchronously. The control unit 130 rearranges the content icons and generation times of the items of user content stored in the memory unit 120 according to a condition input by the user of the communication terminal 100. If a content icon is selected from the virtual wheel, the control unit 130 displays an item of user content corresponding to the content icon.

The audio processing unit 140 plays an audio signal output by the audio codec of the data processing unit through a speaker SPK and outputs an audio signal generated by a microphone MIC to the audio codec of the data processing unit.

The display unit 150 displays an operating status of the communication terminal 100 under the control of the control unit 130. In situations in which an LCD unit is used as the display unit 150, the display unit 150 may include an LCD device, an LCD control unit, and a memory unit for storing data. If the LCD unit provides a touch screen function, the display unit 150 may further operate as an input unit.

The key input unit 160 includes alphanumeric keys for character inputs and function keys for setting various functions.

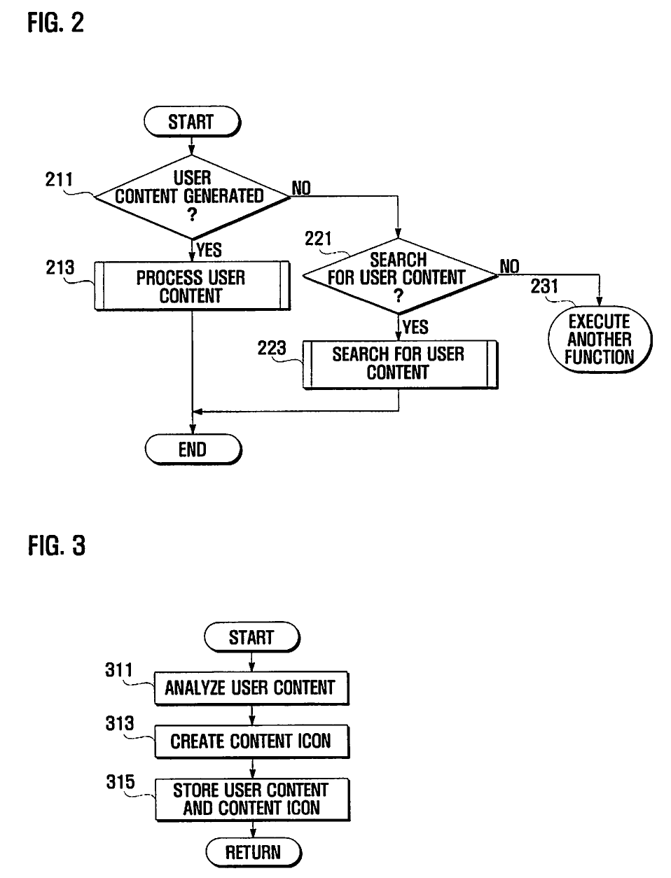

FIG. 2 is a flow chart showing a user content management method according to an embodiment of the present invention.

Referring to FIG. 2, the control unit 130 first determines whether an item of user content is generated at step S211. The item of user content may be, for example, a call, a message, an MP3 file, an image, or a memo, and a generation time of the item of user content may be, for example, the time of call reception, call transmission, message reception, message transmission, MP3 file download, photographing, image reception, or memo preparation. If an item of user content is generated, the control unit 130 processes the generated user content at step S213.

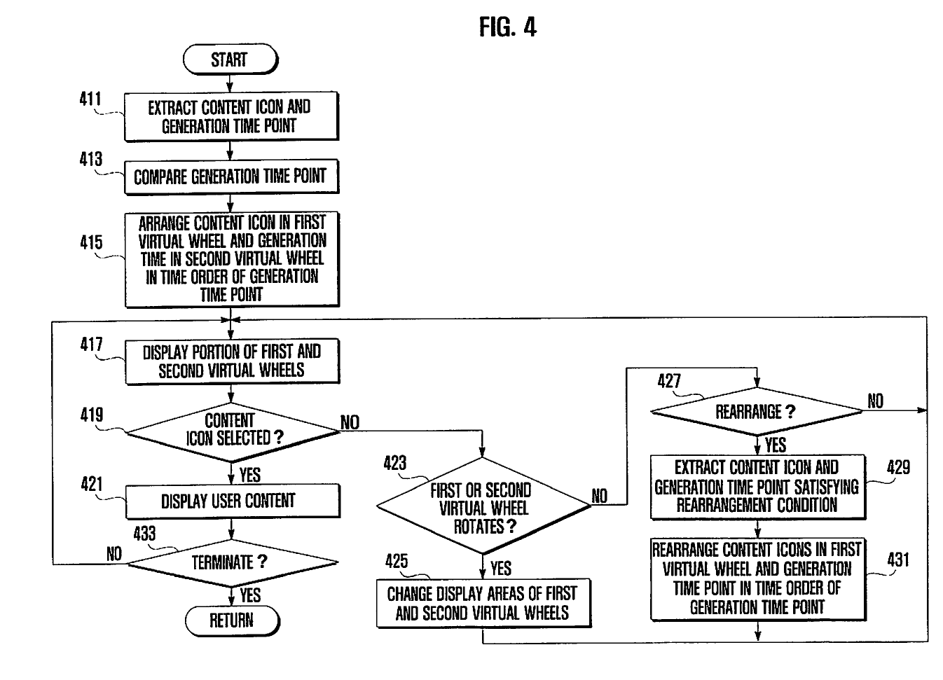

FIG. 3 is a flow chart showing a method of processing an item of user content, according to an embodiment of the present invention. FIG. 3 provides a detailed description of step S213 in the user content management method of FIG. 2.

Referring to FIG. 3, the control unit 130 analyzes the detected item of user content in step S311. The control unit 130 creates a content icon corresponding to the item of user content using the analysis result in step S313. If the item of user content is an image or contains a thumbnail, the control unit 130 may use the thumbnail as the content icon. Otherwise, an image set to the user content may be used as the content icon. If the item of user content is received from a counterpart terminal or transmitted to the counterpart terminal, the control unit 130 may display information of the counterpart terminal user in the content icon, such as a name, a telephone number, or an e-mail address. The control unit 130 stores the item of user content and the content icon corresponding to the item of user content in the memory unit 120 in step S315.

Returning to FIG. 2, if no user content is generated at step S211, the control unit 130 determines whether a request for searching for an item of user content is input through a touch screen or the key input unit 160 in step S221. If a request for searching for an item of user content is not input at step S221, the control unit 130 may perform another function such as setting an item of user content to be displayed in the virtual wheel while searching for an item of user content in step S231.

If a request for searching for an item of user content is not input at step S221, the control unit 130 executes a function of searching for an item of user content in step S223. The control unit 130 searches the items of user content comprehensively and may extract an item of user content requested by the user of the communication terminal 100. The control unit 130 arranges content icons and generation times of each item of user content stored in the memory unit 120 through the virtual wheel such that the user of the communication terminal 100 may select a desired item of user content easily.

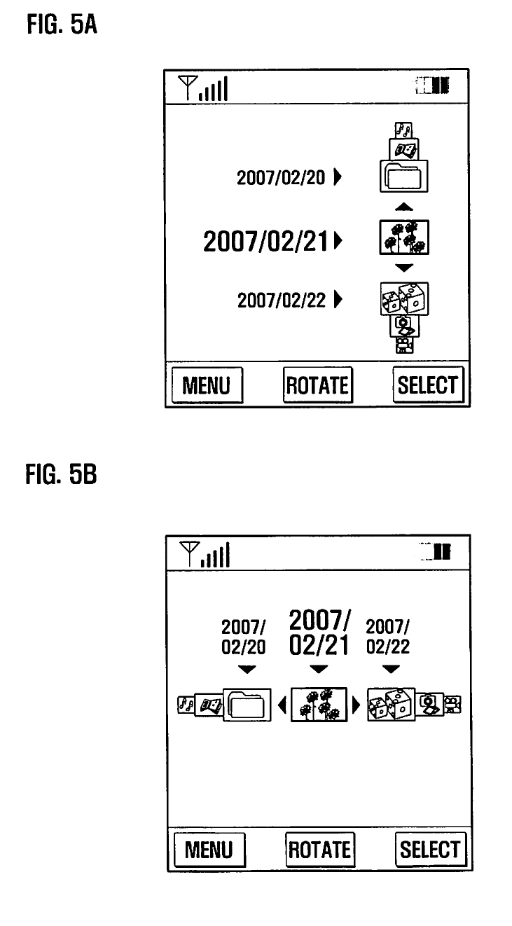

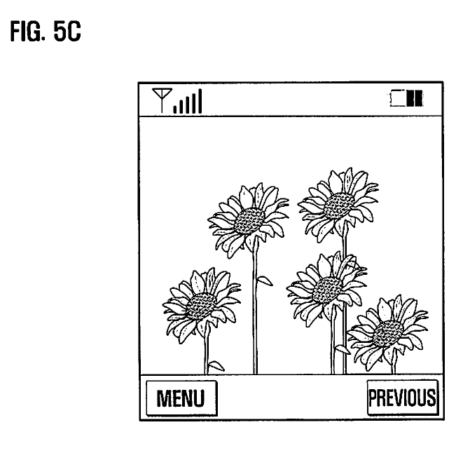

FIG. 4 is a flow chart showing a method of searching for an item of user content, according to an embodiment of the present invention. FIG. 4 provides a detailed description of step S223 in the user content management method of FIG. 2. In this embodiment, a content icon and a generation time of each item of user content are disposed in parallel in two virtual wheels. FIGS. 5A to 5C are display screen output views in the process of searching for a user content of FIG. 4. FIG. 5A is a display screen view showing a portion of a virtual wheel that is displayed in the vertical direction in the display unit 150. FIG. 5B is a display screen view showing a portion of a virtual wheel that is displayed in the horizontal direction in the display unit 150. FIG. 5C is a display screen view showing an item of user content displayed in a full screen after selecting a content icon from the virtual wheel.

Referring again to FIG. 4, if a request for searching for an item of user content is input through a touch screen or the key input unit 160 at step S221 in FIG. 2, the control unit 130 extracts a content icon and a generation time point for each item of user content stored in the memory unit 120 in step S411, and determines an order for each content icon corresponding to an item of user content by comparing the generation date and time of each item of user content in step S413. The control unit 130 then arranges the content icons and generation times in the virtual wheel in order of generation time in step S415. The virtual wheel includes a first virtual wheel and a second virtual wheel, and rotates according to the control of the control unit 130. The control unit 130 arranges the content icons in the first virtual wheel and the generation times in the second virtual wheel in order of generation time.

As shown in FIGS. 5A and 5B, the control unit 130 displays portions of the first virtual wheel and the second virtual wheel in the display unit 150 in step S417. That is, a predetermined number of content icons are displayed in the first virtual wheel and the corresponding generation times are displayed in the second virtual wheel. The control unit 130 displays a content icon located in the center of the first virtual wheel in a size larger than the size of content icons located at the ends of the first virtual wheel. The control unit 130 displays a generation time point located in the center of the second virtual wheel in a size larger than the size of generation times located at the ends of the second virtual wheel. The number of the content icons and the number of generation times to be displayed in the display unit 150 may be predetermined according to the size of the display unit 150. The control unit 130 may further display a generation date of the item of user content in the second virtual wheel. The control unit 130 may further display a portion of the first or second virtual wheels in the full screen of the display unit 150.

If a content icon is selected from the display unit 150 through a touch screen or the key input unit 160 in step S419, the control unit 130 displays an item of user content corresponding to the selected content icon, as shown in FIG. 5C in step S421. Windows for displaying the first virtual wheel, the second virtual wheel, and the item of user content may be displayed in different screens, or may be displayed in different display areas of a single screen.

If a content icon is not selected from the display unit 150 at step S419, and if rotation of the first or second virtual wheel is requested in step S423, the control unit 130 changes the display areas of the first and second virtual wheels in the display unit 150 in step S425. The rotation of the first or second virtual wheel may be induced by a scroll operation of the terminal user. The control unit 130 rotates the first and second virtual wheels synchronously and the direction of rotation is determined by the scroll operation of the terminal user. While rotating the first and second virtual wheels at step S425, the control unit 130 returns to step S417 and displays the changing display areas of the first and second virtual wheels in the display unit 150 to represent the rotation in step S417. Steps S417, S419, S423, and S425 may be repeated until either the user selects a content icon at step S419 or the scroll operation for rotating the first or second virtual wheel is no longer requested at step S423.

If rotation of the first or second virtual wheel is not requested at step S423, and if rearrangement of the content icons is requested at step S427, the control unit 130 extracts a portion of the content icons and generation time points displayed in the virtual wheel in step S429. That is, according to an arrangement condition input by the user of the communication terminal 100, the control unit 130 extracts content icons and generation times satisfying the arrangement condition from the memory unit 120. The control unit 130 rearranges the extracted content icons in the first virtual wheel and generation times in the second virtual wheel in order of generation time in step S431. Subsequently, the control unit 130 returns to step S417 and displays a portion of the rearranged content icons in the first virtual wheel and generation times in the second virtual wheel.

The condition for rearranging the content icons and generation time points may be a generation time. In this case, the control unit 130 displays only the content icons and generation times corresponding to a specific date in the virtual wheel. Further, the condition for rearranging the content icons and generation times may be an item of user content. In this case, the control unit 130 displays only the content icons and generation times corresponding to a specific type of user content in the virtual wheel. For example, only the content icons and generation times of items of user content corresponding to a specific message may be extracted from the memory unit 120 and displayed in the virtual wheel. Further, the condition of rearranging the content icons and generation times may be a tag contained in the items of user content. In this situation, the control unit 130 displays only the content icons and generation times of items of user content containing a specific tag in the virtual wheel. Further, the condition for rearranging the content icons and generation times may be a keyword input by the user of the communication terminal 100. In this situation, the control unit 130 displays only the content icons and generation times of items of user content containing a specific keyword in the virtual wheel.

The control unit 130 repeats steps S417, S419, and S423 to S431 until the user selects a content icon from the screen of the display unit 150 at step S419.

While displaying an item of user content corresponding to a specific content icon at step S421, if termination of a search for an item of user content is requested at step S433, the control unit 130 terminates the steps of searching for an item of user content, and the process returns to the flow chart of FIG. 2.

If termination of a search for an item of user content is not requested at step S433, the control unit 130 returns to step S417 and continues to display portions of the first and second virtual wheels in the display unit 150.

As described above, a user content management method according to an embodiment of the present invention enables comprehensive searching of items of user content according to a request from a user of a communication terminal, because a content icon and generation time of each item of user content stored in the communication terminal are displayed in a virtual wheel in temporal order while searching for an item of user content. Therefore, an item of user content desired by the user of the communication terminal may be selected easily.

While the invention has been shown and described with reference to certain preferred embodiments thereof, it will be understood by those skilled in the art that various changes in form and details may be made therein without departing from the spirit and scope of the invention as defined by the appended claims.

For example, when processing items of user content created by a communication terminal, a content icon and a generation time of an item of user content may be extracted and added to a virtual wheel displaying content icons and generation times of pre-stored items of user contents.

Further, when searching for an item of user content in a communication terminal, a content icon and a generation time of each item of user content stored in the communication terminal may be displayed in a single virtual wheel. In this case, the generation time may be disposed in a separate column or in a separate row adjacent to the content icon.

What is claimed is:

1. A user content management method in a communication terminal, said method comprising:
displaying a virtual wheel in which one or more content icons corresponding to one or more items of user content and generation times of the one or more items of user content in the vicinity of the content icons, wherein the content icons are arranged in temporal order according to generation time.

2. The user content management method of claim 1, further comprising:
changing a display area of the virtual wheel, when the virtual wheel rotates.

3. The user content management method of claim 2, wherein displaying a predetermined area of a virtual wheel comprises extracting at least one of the one or more content icons satisfying a condition and rearranging the at least one of the one or more content icons in temporal order according to generation time in the virtual wheel, when the condition of rearranging the one or more content icons is satisfied.

4. The user content management method of claim 3, wherein a generation time is disposed at a side of a corresponding content icon.

5. The user content management method of claim 4, wherein the one or more content icons and the one or more generation times are arranged in different columns in the virtual wheel.

6. The user content management method of claim 4, wherein the one or more content icons and the one or more generation times are arranged in different rows in the virtual wheel.

7. The user content management method of claim 3, further comprising:
creating a content icon corresponding to an item of user content, when the item of user content is generated; and
storing the content icon.

8. The user content management method of claim 2, further comprising displaying an item of user content corresponding to a content icon before changing the display area of the virtual wheel, when the content icon is selected from the display area.

9. The user content management method of claim 2, further comprising displaying an item of user content corresponding to a content icon after changing the display area of the virtual wheel, when the content icon is selected from the display area.

10. The user content management method of claim 4, wherein sizes of a content icon and of a generation time located in a center of the display area of the virtual wheel are greater than sizes of a content icon and of a generation time point, respectively, located at an end of the display area of the virtual wheel.

11. The user content management method of claim 3, wherein the condition for rearranging the one or more content icons is at least one of a generation time point, an item of user content, a tag contained in an item of user content, and a keyword input by a user of the communication terminal.

12. The user content management method of claim 2, wherein changing the display areas comprises rotating the virtual wheel according to requested scrolling, when scrolling is requested.
